(19) United States
(12) Patent Application Publication
(10) Pub. No.: US 2026/0205352 A1
(43) Pub. Date: Jul. 16, 2026

(54) CONTENT DELIVERY NETWORK CONFIGURATION

(71) Applicant: Salesforce, Inc., San Francisco, CA (US)

(72) Inventors: Kris Botha, British Columbia (CA); Shauli Gal, San Francisco, CA (US); Russell Larsen, San Francisco, CA (US); Aditya Vidhyadhara Kamath, San Francisco, CA (US); Satish Raghunath, San Francisco, CA (US)

(21) Appl. No.: 19/024,977

(22) Filed: Jan. 16, 2025

(51) Int. Cl. H04L 41/0806; G06F 9/54

(52) U.S. Cl. CPC H04L 41/0806; G06F 9/547

(57) ABSTRACT

Systems, devices, and techniques are disclosed for content delivery network configuration. An API request may include a description in an API language may be received. The description may include HTTP protocols, methods, header policies, certificate data, origins, and routing rules. Asynchronous processes may configure a first content delivery network based on the description. One of the asynchronous processes may interact with a certificate service. Additional asynchronous processes may configure a second content delivery network based on the description. The description may not be changed based on configuration parameters of the second content delivery network. The configuration parameters of the second content delivery network may be different from configuration parameters of the first content delivery network.

### BACKGROUND

Operational management, configuration updates, and monitoring for an organization’s TLS termination stacks that terminate at content delivery networks may be resource intensive. Different content delivery networks may have differing implementations. This may require an organization that wants to move from one content delivery network to another, or to use multiple different content delivery networks, to devote additional resources to each content delivery network to account for the differences in implementations.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system suitable for content delivery network configuration according to an implementation of the disclosed subject matter.

FIG. 2A shows an example arrangement suitable for content delivery network configuration according to an implementation of the disclosed subject matter.

FIG. 2B shows an example arrangement suitable for content delivery network configuration according to an implementation of the disclosed subject matter.

FIG. 3 shows an example arrangement suitable for content delivery network configuration according to an implementation of the disclosed subject matter.

FIG. 4A shows an example arrangement suitable for content delivery network configuration according to an implementation of the disclosed subject matter.

FIG. 4B shows an example arrangement suitable for content delivery network configuration according to an implementation of the disclosed subject matter.

FIG. 5 shows an example procedure suitable for content delivery network configuration according to an implementation of the disclosed subject matter.

FIG. 6 shows an example procedure suitable for content delivery network configuration according to an implementation of the disclosed subject matter.

FIG. 7 shows an example procedure suitable for content delivery network configuration according to an implementation of the disclosed subject matter.

FIG. 8 shows a computer according to an implementation of the disclosed subject matter.

FIG. 9 shows a network configuration according to an implementation of the disclosed subject matter.

### DETAILED DESCRIPTION

Techniques disclosed herein enable content delivery network configuration, which may allow for the configuration of content delivery networks (CDNs) based on a description written in a provider-agnostic language. An API request including a description in an API language may be received. The description may include HTTP protocols, methods, header policies, certificate data, origins, and routing rules. A first content delivery network may be configured by one or more asynchronous processes based on the description. An asynchronous process may interact with a certificate service. A second content delivery network may be configured by additional asynchronous processes based on the description. The description may not be changed based on configuration parameters of the second content delivery network, which may be different from configuration parameters of the first content delivery network. An append-only log of deployment requests may be updated with the description of the API request. Configuration patterns based on the description of the API request may be stored. An asynchronous process may use the configuration patterns when configuring the first content delivery network and an additional asynchronous process may use the configuration patterns when configurating the second content delivery network.

An API request including a description in an API language may be received. The API language may be a content delivery network-agnostic language that may be used to write an API request that describes high-level intent for the configuration of a content delivery network. The API language may not be specific to the syntax used to set configuration parameters used by any particular content delivery network. The description, written using the API language may include the specification of suitable configuration data that may be used when configuring a content delivery network, including, for example, HTTP protocols, methods, header policies, certificate data, origins, and routing rules. The API request may be received by any suitable system, such as, for example, at a control plane server that may be part of a cloud computing server system. The API request may be submitted by, for example, a user or tenant of the cloud computing server system, which may be a multi-tenant system.

A first content delivery network may be configured by one or more asynchronous processes based on the description. The control plane server may, for example, spawn asynchronous processes that may use the specification of configuration data from the description included in the API requests to configure a content delivery network. The content delivery network may be part of a server system that may include the control plane server or may be implemented as part of a separate server system, such as a second, distinct, cloud computing server system. An asynchronous process may generate a CDN deployment environment. The CDN deployment environment may be a data structure object that includes a description of host patterns, certificates, and other suitable data needed to configure a CDN to perform traffic routing based on the high-level intent in the description of the API request. An asynchronous process may generate a CDN domain environment. The CDN domain environment may be a data structure object that includes domain name data that may be needed to configure a CDN based on the high-level intent in the description of the API request. An asynchronous process may generate a CDN certificate environment. The CDN certificate environment may be a data structure object that includes certificate data that may be needed to configure a CDN based on the high-level intent in the description of the API request. An asynchronous process may interact with an appropriate certificate service through certificate signing requests (CSRs) to obtain certificates for use with the first content delivery network. An asynchronous process may interact with the first content delivery network to perform domain mapping. An asynchronous process may interact with the first content delivery network to perform certificate upsertion. This may result in the configuration of the first content delivery network based on the high-level intent for the configuration of a content delivery network in the description of the API request. Interactions between the asynchronous processes and the first content delivery network may be mediated through a driver for the first content delivery network. The driver may be part of the control plane server and may allow the specification of configuration data in the API language to be used by the asynchronous processes to configure the first content delivery network. For example, the driver may allow a conversion from the API language to the syntax used by the first content delivery network to set the configuration parameters of the first content delivery network. The driver for the first content delivery network may also allow the asynchronous processes to use APIs made available by the first content delivery network for configuration of the first content delivery network. The use of asynchronous processes may allow for the configuration of the first content delivery network to be protected against system restarts that may occur during the time the asynchronous processes are running, as some of the asynchronous processes, such as the any that interact with a CSR, may take longer periods of time to complete.

A second content delivery network may be configured by additional asynchronous processes based on the description. The description may not be changed based on configuration parameters of the second content delivery network, which may be different from configuration parameters of the first content delivery network. The control plane server may, for example, spawn additional asynchronous processes that may use the specification of configuration data from the description included in the API requests to configure a second content delivery network that may be different from the first content delivery network. The second content delivery network may be part of the server system that may include the control plane server or may be implemented as part of a separate server system, such as a third, distinct, cloud computing server system from the server system that includes the control plane server and the server system that includes the first content delivery network. The additional asynchronous processes may use the CDN deployment environment, CDN domain environment, and CDN certificate environment objects that may have already been generated from the description in the API request. One of the additional asynchronous processes may interact with an appropriate certificate signing service to obtain certificates for use with the second content delivery network. Another of the additional asynchronous processes may interact with the second content delivery network to perform domain mapping. Another of the additional asynchronous processes may interact with the second content delivery network to perform certificate upsertion. This may result in the configuration of the second content delivery network based on the high-level intent for the configuration of a content delivery network in the description of the API request, which may be the same API request used to configure the first content delivery network. The configuration parameters, including syntax and APIs, used by the second content delivery network may differ from the configuration parameters, including syntax and APIs, used by the first content delivery network. Interactions between the additional asynchronous processes and the second content delivery network may be mediated through a driver for the second content delivery network, which may be different from the driver for the first content delivery network. The driver for the second content delivery network may be part of the control plane server and may allow the specification of configuration data in the API language to be used by the asynchronous processes to configure the second content delivery network. The driver for the second content delivery network may also allow the asynchronous processes to use APIs made available by the second content delivery network for configuration of the second content delivery network. The APIs made available by the second content delivery network may be different than the APIs made available by the first content delivery network.

The use of asynchronous processes may allow for the configuration of the second content delivery network to be protected against system restarts that may occur during the time the asynchronous processes are running, as some of the asynchronous processes, such as the any that interact with a CSR, may take longer periods of time to complete. A single user or tenant the cloud computing server system may be able to have multiple content delivery networks configured on their behalf using the same description in the API language from the same API request without needing to adjust the description to account for variations across the multiple content delivery networks, for example, variations in syntax used to configure the content delivery networks. The control plane server may include a separate driver for any number of content delivery networks that may allow for the reuse of the description in the API request.

An append-only log of deployment requests may be updated with the description of the API request. The append-only log may be stored by the control plane server and may include all API requests received by the control plane server. The control plane server may also maintain the appropriate database tables and objects that may represent the configuration described by the descriptions of the API requests received at the control plane server.

Configuration patterns based on the description of the API request may be stored. For example, a CDN deployment environment generated based on an API request may include the configuration patterns, for example, description of host patterns, certificates, and other suitable parameters needed to configure a CDN to perform traffic routing. A CDN deployment environment generated from an API request may be stored in any suitable storage by the control plane server. An asynchronous process may use the configuration patterns, for example, from a stored CDN deployment environment, when configuring the first content delivery network and an additional asynchronous process may use the same configuration patterns from the same CDN deployment environment when configurating the second content delivery network based on the same description from the API request used in configuring the first content delivery network.

The control plane server may use stateful variables that may be used by asynchronous processes during the configuration of a content delivery network. The stateful variables may be stored in any suitable manner, including, for example, as a part of a properties map that may be associated with objects, such as the CDN deployment environment, which represent the desired configuration for a content delivery network.

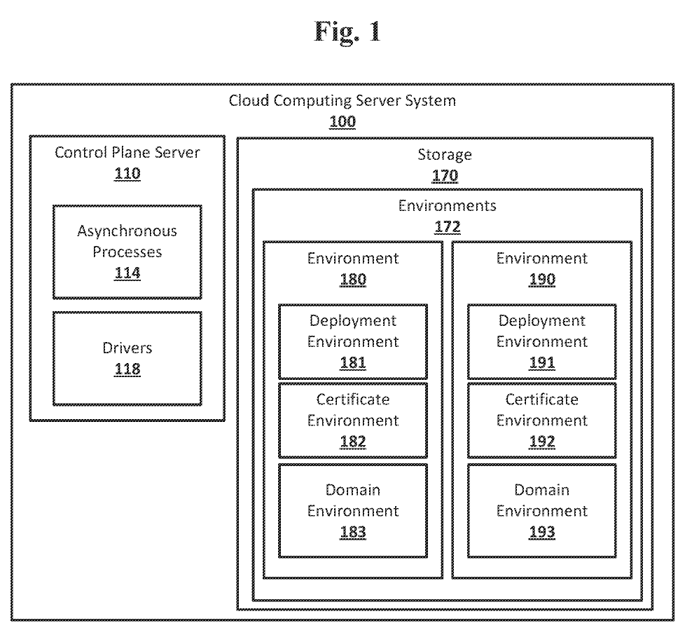

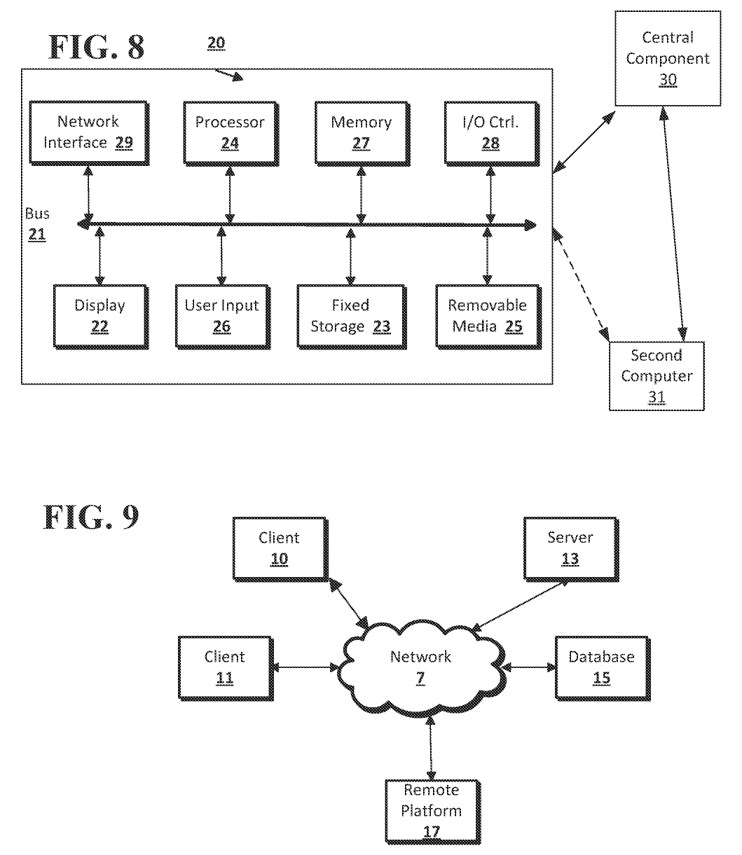

FIG. 1 shows an example system suitable for content delivery network configuration according to an implementation of the disclosed subject matter. A cloud computing server system 100 may be a server system that may include computing devices such as, for example, the computer 20 as described in FIG. 8, or components thereof. The cloud computing server system 100 may include any number computing devices, each of which may include any suitable combination of central processing units (CPUs), graphical processing units (GPUs), and tensor processing units (TPUs). The cloud computing server system 100 may be distributed over any geographic area, and may, for example, include geographically disparate computing devices connected through any suitable network connections. The cloud computing server system 100 may be a multi-tenanted server system.

The cloud computing server system 100 may include a control plane server 110. The control plane server 110 may be any suitable combination of hardware and software on the cloud computing server system 100 that may generate asynchronous processes 114 to configure content delivery networks based on a description written in an API language received in an API request. The control plane server 110 may, for example, be implemented directly on physical computing devices of the cloud computing server system 100 or on virtual machines running on physical computing devices of the cloud computing server system 100.

The asynchronous processes 114 may be processes spawned by the control plane server 110 that may run asynchronously on the computing devices of the cloud computing server system 100. The asynchronous processes 114 may perform actions that may configure a content delivery network according to the high-level intent of a description written in API language and received in an API request. The API request may be sent to the control plane server 110 by, for example, a tenant of the cloud computing server system 100. The asynchronous processes 114 may use drivers 118 when configuring content delivery networks. The drivers 118 may include drivers that may be specific to various different content delivery networks and may allow the asynchronous processes 114 to configure the content delivery networks based on the high-level intent of the description written in the API language and using any necessary syntax required by the content delivery networks and may also allow the asynchronous processes 114 to use APIs made available by content delivery networks for configuration of the content delivery networks. This may allow the API language to be content delivery network-agnostic. Multiple different content delivery networks may be configured using the same description written in the API language from the same API request without requiring that the description be changed based on the content delivery network being configured. The control plane server 110 may spawn any suitable number of asynchronous processes 114 in any order to configure a content delivery network, and various asynchronous processes 114 may be given any number of suitable tasks to complete to configure a content delivery network. The asynchronous processes 114 may run asynchronously, completing tasks independently of each other, and may be terminated by the control plane server 110 when they have completed their tasks.

The cloud computing server system 100 may include a storage 170. The storage 170 may be any suitable combination of hardware and software for storing data on any suitable physical storage mediums that may be part of or accessible to the cloud computing server system 100, including local storage and storage accessible over wired or wireless connections including network connections. The storage 170 may store environment 172. The environments 172 may be content delivery network environments that may be generated by the control plane server 110, for example, using the asynchronous processes 114, from a received API request that includes a description written in the API language. Every distinct API request may have a corresponding environment generated and stored in the environments 172. For example, a first API request may be used by the control plane server 110 to generate the environment 180, including a deployment environment 181, a certificate environment 182, and a domain environment 183. A second API request may be used by the control plane server 110 to generate an environment 190, including deployment environment 191, a certificate environment 192, and a domain environment 193. The environments 172 may be stored in the form of an append-only log.

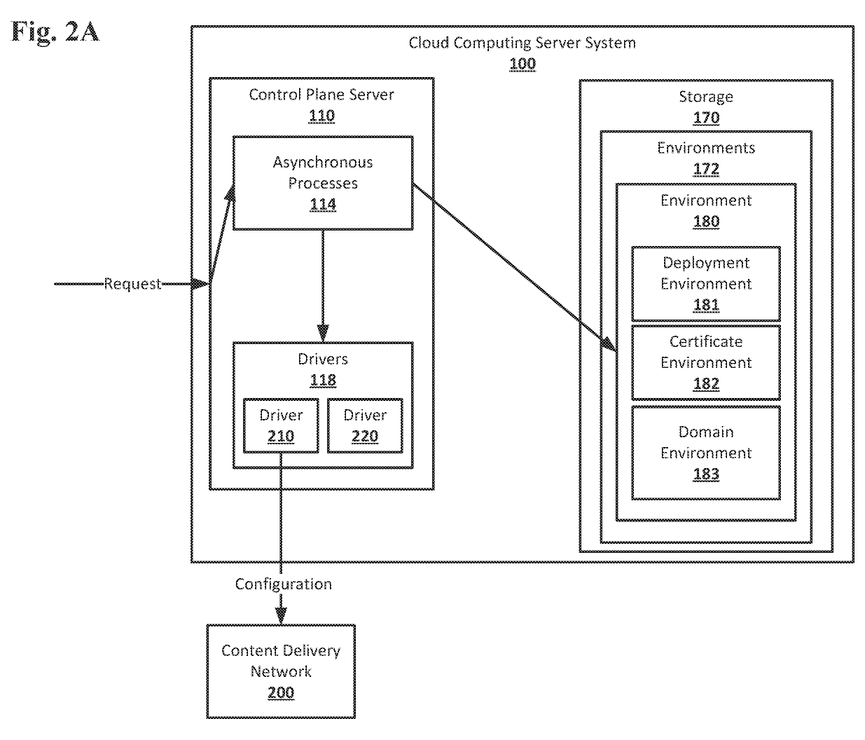

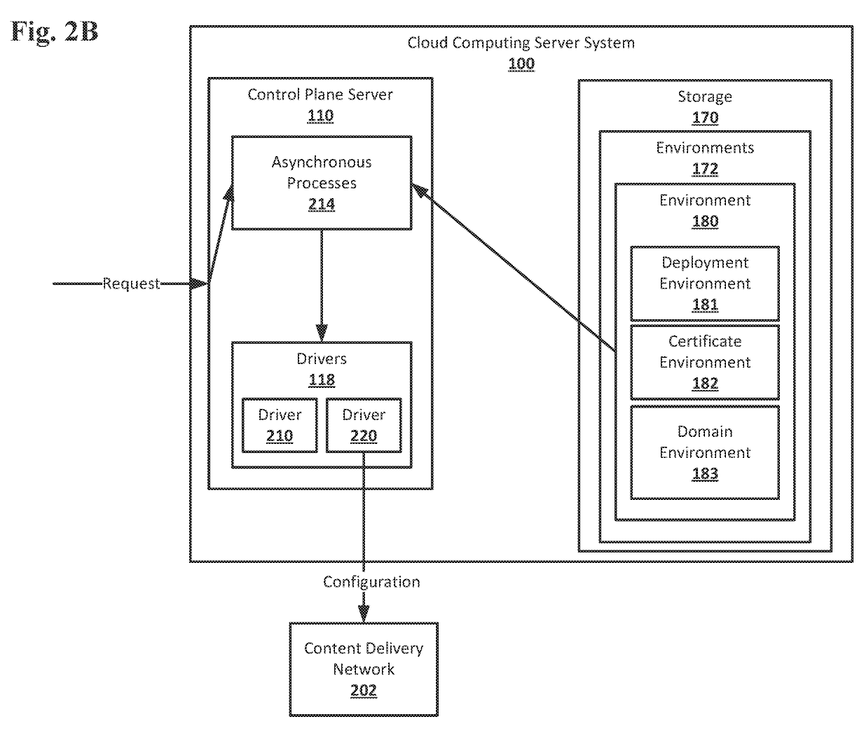

FIG. 2A shows an example arrangement suitable for content delivery network configuration according to an implementation of the disclosed subject matter. A request including a description written in the API language may be received at the cloud computing server system 100. The request may be, for example, an API request. The request may be received from, for example, a tenant of the cloud computing server system. The request may include an indication that a content delivery network should be configured based on the description and may or may not identify a specific content delivery network. The request may include, for example, HTTP protocols, methods, header policies, certificate data, origins, and routing rules.

The request may be processed by the control plane server 110. The control plane server 110 may spawn asynchronous processes 114. The asynchronous processes 114 may generate the environment 180, including the deployment environment 181, the certificate environment 182, and the domain environment 183, from the description written in the API language in the request. The environment 180 may be stored with the environments 172 in the storage 170.

The asynchronous processes 114 may configure a content delivery network 200 in accordance with the description written in the API language in the request based on the environment 180. The content delivery network 200 may be any suitable content delivery network, and may be, for example, part of the cloud computing server system 100, or may be part of a separate cloud computing server system. The asynchronous processes 114 may interact with the content delivery network 200 through a driver 210 from the drivers 118. The driver 210 may be a driver specific to the content delivery network 200 that may allow the asynchronous processes 114 to configure the content delivery network 200 based on the description written in the API language while using syntax and parameters that are specific to the content delivery network 200, for example, through APIs made available by the content delivery network 200. The asynchronous processes 114 may end once the content delivery network 200 has been properly configured. The environment 180 may remain stored in the storage 170.

FIG. 2B shows an example arrangement suitable for content delivery network configuration according to an implementation of the disclosed subject matter. A request may be received at the cloud computing server system 100. The request may be, for example, an API request. The request may be received from, for example, the tenant of the cloud computing server system that sent the request that included the description used to generate the environment 180 and configure the content delivery network 200. The request may include an indication that a content delivery network should be configured based on the previously received description and may or may not identify a specific content delivery network.

The request may be processed by the control plane server 110. The control plane server 110 may spawn asynchronous processes 214. The asynchronous processes 214 may retrieve the environment 180, including the deployment environment 181, the certificate environment 182, and the domain environment 183, from the environments 172 in the storage 170.

The asynchronous processes 214 may configure a content delivery network 202 in accordance with the environment 180. The content delivery network 202 may be any suitable content delivery network, and may be, for example, part of the cloud computing server system 100, or may be part of a separate cloud computing server system. The content delivery network 202 may be separate from the content delivery network 200, and may, for example, use configuration parameters, including different syntax and APIs. The asynchronous processes 214 may interact with the content delivery network 202 through a driver 220 from the drivers 118. The driver 220 may be a driver specific to the content delivery network 202 that may allow the asynchronous processes 214 to configure the content delivery network 202 based on the environment 180, generated from the description written in the API language, while using syntax and parameters that are specific to the content delivery network 202 for example, through APIs made available by the content delivery network 202. The asynchronous processes 214 may end once the content delivery network 202 has been properly configured. The environment 180 may remain stored in the storage 170. The environment 180 may be used to configure any number of different content delivery networks regardless of the use of different APIs, syntax, and parameters by the different content delivery networks.

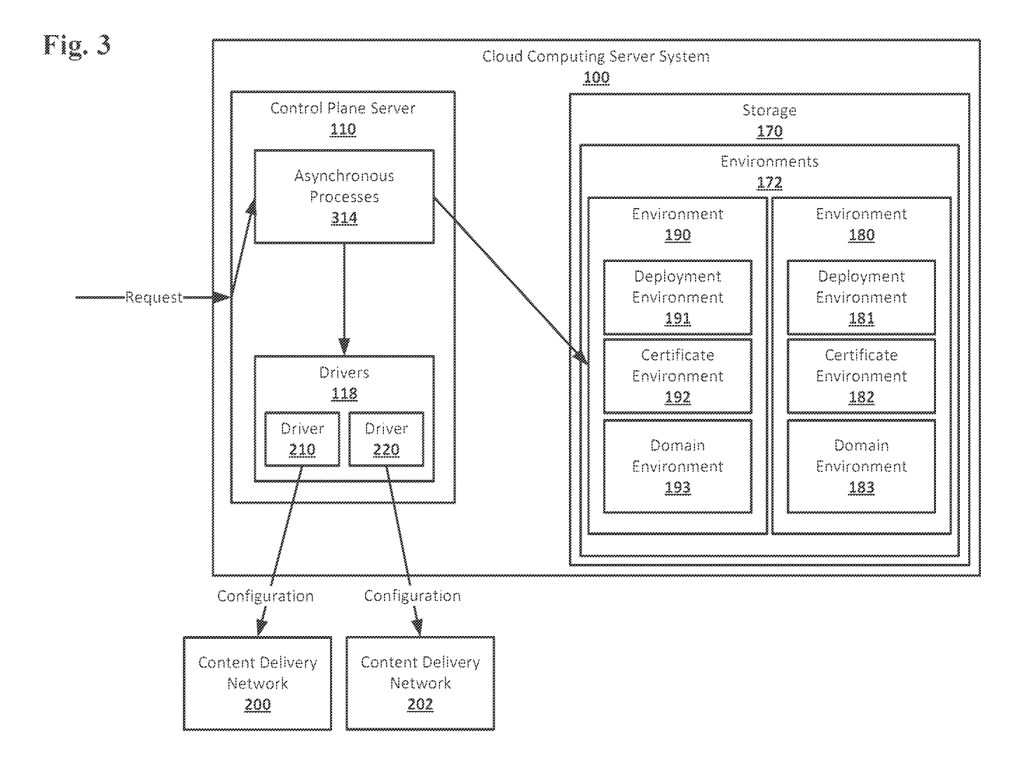

FIG. 3 shows an example arrangement suitable for content delivery network configuration according to an implementation of the disclosed subject matter. A request including a description written in the API language may be received at the cloud computing server system 100. The request may be, for example, an API request. The request may be received from, for example, a tenant of the cloud computing server system that may be different from the tenant that sent the request used to generate the environment 180. The request may include an indication that multiple content delivery networks should be configured based on the description and may or may not identify specific content delivery networks.

The request may be processed by the control plane server 110. The control plane server 110 may spawn asynchronous processes 314. The asynchronous processes 314 may generate the environment 190, including the deployment environment 191, the certificate environment 192, and the domain environment 193, from the description written in the API language in the request. The environment 190 may be stored with the environments 172 in the storage 170.

The asynchronous processes 314 may configure the content delivery network 200 and the content delivery network 202 in accordance with the description written in the API language in the request based on the environment 190. The asynchronous processes 314 may interact with the content delivery network 200 through the driver 210 from the drivers 118 and with the content delivery network 202 through the driver 220 from the drivers 118. The asynchronous processes 314 may end once the content delivery network 200 and the content delivery network 202 have been properly configured. The environment 190 may remain stored in the storage 170.

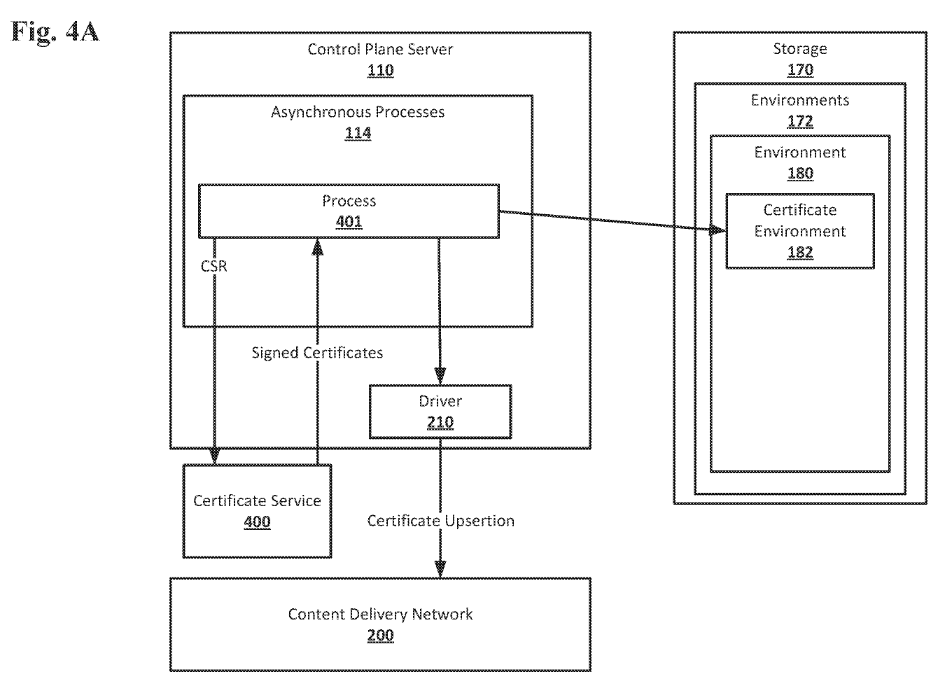

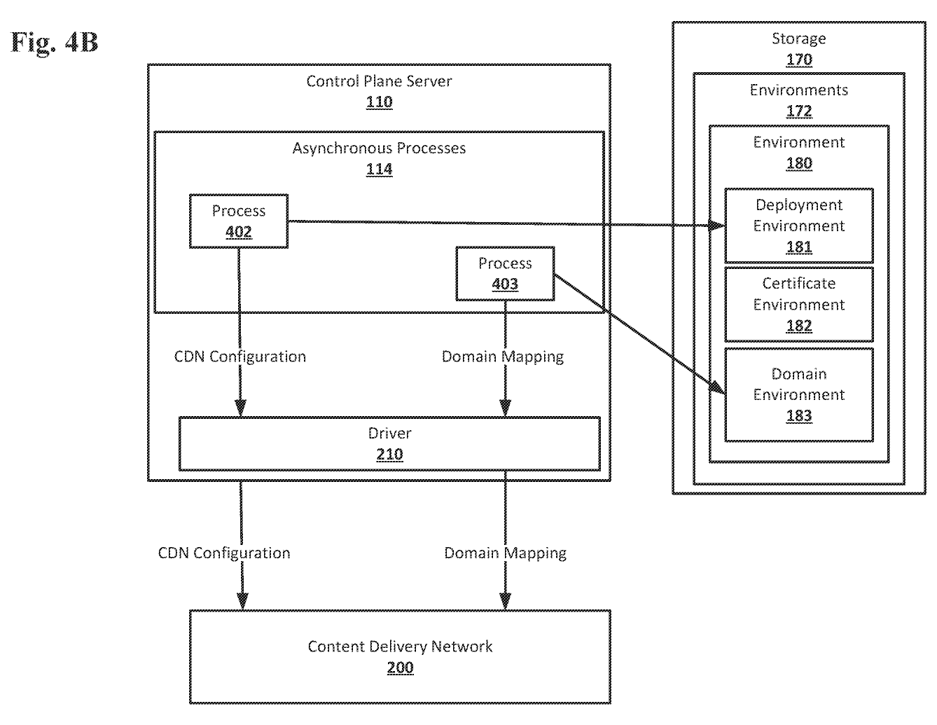

FIG. 4A shows an example arrangement suitable for content delivery network configuration according to an implementation of the disclosed subject matter. In response to receiving an API request that includes a description written in the API language, the control plane server 110 may spawn an asynchronous process 401. The asynchronous process 401 may send any suitable number of certificate signing requests (CSRs) to a certificate service 400. The CSRs may be for certificates that may be needed to configure the content delivery network 200 based on the received API request. The certificate service 400 may be any suitable certificate service running on any suitable computing device and may sign any suitable type of certificate, such as, for example, sign transport layer security (TLS) certificates. The process 401 may receive signed certificates from the certificate service 400. The process 401 may then upsert the signed certificates to the content delivery network 200. The process 401 may use the driver 210 to interact with the content delivery network 200 during certificate upsertion, allowing the process 401 to send API requests to the content delivery network 200. The process 401 may also generate the certificate environment 182 based on data from the API request used to generate the CSRs.

FIG. 4B shows an example arrangement suitable for content delivery network configuration according to an implementation of the disclosed subject matter. In response to receiving an API request that includes a description written in the API language, the control plane server 110 may spawn asynchronous processes 402 and 403. The asynchronous process 402 may perform CDN configuration of any suitable parameters of the content delivery network 200 based on configuration data in the received API request. The asynchronous process 402 may interact with the content delivery network 200 through the driver 210, which may allow the asynchronous process 402 to send API requests to the content delivery network 200. The asynchronous process 402 may also generate the deployment environment 181 based on the configuration patterns from the API request used to configure the content delivery network 200. The asynchronous process 403 may perform domain mapping on the content delivery network 200 based on domain data in the received API request. The asynchronous process 403 may interact with the content delivery network 200 through the driver 210, which may allow the asynchronous process 403 to send API requests to the content delivery network 200. The asynchronous process 403 may also generate the domain environment 183 based on the domain data from the API request used to perform domain mapping on the content delivery network 200.

The asynchronous processes 401, 402, and 403 may all be asynchronous, may be spawned in any order, and may finish in any order. The control plane server 110 may terminate the asynchronous processes 401, 402, and 403, when they have completed.

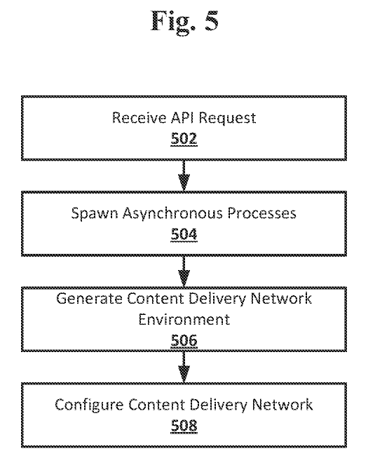

FIG. 5 shows an example procedure suitable for content delivery network configuration according to an implementation of the disclosed subject matter. At 502, an API request may be received. For example, an API request may be received at a control plane server 110 of a cloud computing server system 100. The API request may be a request from, for example, a tenant of the cloud computing server system to configure content delivery networks, such as the content delivery networks 200 and 202, for the tenant. The API request may include a description written in an API language. The description may specify the high-level intent for the configuration of content delivery networks and may include, for example, HTTP protocols, methods, header policies, certificate data, origins, and routing rules.

At 504, asynchronous processes may be spawned. For example, the control plane server 110 may spawn the asynchronous processes 114, which may include, for example, asynchronous processes 401, 402, and 403. The asynchronous processes 114 may be assigned tasks to complete to configure a content delivery network, such as the content delivery network 200, based on the description in the received API request. The asynchronous processes 114, after being spawned, may run asynchronously to complete their assigned tasks.

At 506, a content delivery network environment may be generated. For example, the asynchronous processes 114 may generate the environment 180, including the deployment environment 181, the certificate environment 182, and the domain environment 183, based on the description in the API request. The data in the environment 180 may be CDN agnostic and may be usable to configure other content delivery networks aside from the content delivery network 200. The environment 180 may be stored in the storage 170 of the cloud computing server system 100.

At 508, a content delivery network may be configured. For example, the asynchronous processes 114 may configure the content delivery network 200 based on the description in the received API request. The asynchronous processes 114 may, for example, send CSRs to the certificate service 400, receive signed certificates, upsert signed certificates to the content delivery network 200, perform domaining mapping on the content delivery network 200, and perform CDN configuration on the content delivery network 200. The asynchronous processes 114 may interact with the content delivery network 200 through the driver 210.

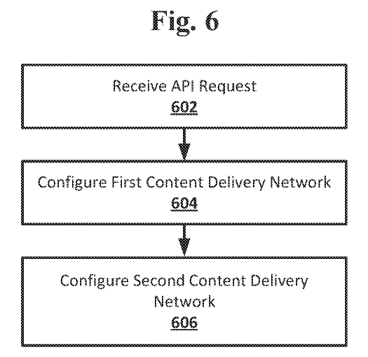

FIG. 6 shows an example procedure suitable for content delivery network configuration according to an implementation of the disclosed subject matter. At 602, an API request may be received. For example, an API request may be received at a control plane server 110 of a cloud computing server system 100. The API request may be a request from, for example, a tenant of the cloud computing server system to configure content delivery networks, such as the content delivery networks 200 and 202, for the tenant. The API request may include a description written in an API language. The description may specify the high-level intent for the configuration of content delivery networks and may include, for example, HTTP protocols, methods, header policies, certificate data, origins, and routing rules.

At 604, a first content delivery network may be configured. For example, the control plane server 100 may spawn asynchronous processes 114 that may configure the content delivery network 200 based on the API request. The asynchronous processes 114 may interact with the content delivery network 200 through the driver 210.

At 606, a second content delivery network may be configured. For example, the control plane server 100 may spawn asynchronous processes 214 that may configure the content delivery network 22 based on the API request. The asynchronous processes 214 may interact with the content delivery network 200 through the driver 202. The asynchronous processes 114 and the asynchronous processes 214 may be spawned and terminated in any order, for example, based on whether the content delivery networks 200 and 202 are configured contemporaneously or sequentially. The asynchronous processes 114 and 214 may both operate directly based on the API request or may be based on the environment 180 if it has already been generated from the API request. Neither the description from the API request nor the environment 180 may need to be changed in order to allow for configuration of both he content delivery network 200 and the content delivery network 202, as the description and the environment 180 may be CDN agnostic. The drivers 210 and 220 may allow the asynchronous processes 114 and 214 to interact with and configure the content delivery networks 210 and 220 based on the CDN agnostic description or data from the environment 180.

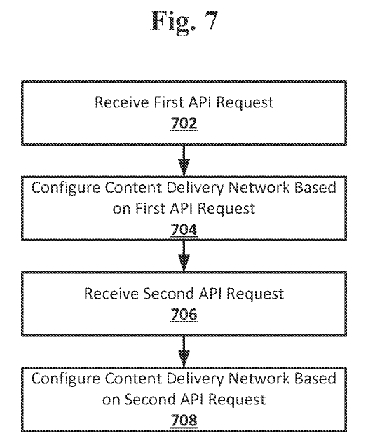

FIG. 7 shows an example procedure suitable for content delivery network configuration according to an implementation of the disclosed subject matter. At 602, a first API request may be received. For example, an API request may be received at a control plane server 110 of a cloud computing server system 100. The API request may be a request from, for example, a tenant of the cloud computing server system to configure content delivery networks, such as the content delivery networks 200 and 202, for the tenant. The API request may include a description written in an API language. The description may specify the high-level intent for the configuration of content delivery networks and may include, for example, HTTP protocols, methods, header policies, certificate data, origins, and routing rules.

At 704, a content delivery network may be configured based on the first API request. For example, the control plane server 100 may spawn asynchronous processes 114 that may configure the content delivery network 200 based on the API request. The asynchronous processes 114 may interact with the content delivery network 200 through the driver 210.

At 706, a second API request may be received. For example, a second API request may be received at a control plane server 110 of a cloud computing server system 100. The second API request may be a request from, for example, a second tenant of the cloud computing server system to configure content delivery networks, such as the content delivery networks 200 and 202, for the second tenant. The second API request may include a description written in an API language. The description may specify the high-level intent for the configuration of content delivery networks and may include, for example, HTTP protocols, methods, header policies, certificate data, origins, and routing rules.

At 706, a content delivery network may be configured based on the second API request. For example, the control plane server 100 may spawn asynchronous processes 314 that may configure the content delivery networks 200 and 202 based on the second API request. The asynchronous processes 114 may interact with the content delivery network 200 through the driver 210 and with the content delivery network 202 through the driver 220.

Implementations of the presently disclosed subject matter may be implemented in and used with a variety of components and network architectures. FIG. 8 is an example computer 20 suitable for implementing implementations of the presently disclosed subject matter. As discussed in further detail herein, the computer 20 may be a single computer in a network of multiple computers. As shown in FIG. 8, computer 20 may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 may enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 9.

Many other devices or components (not shown) may be connected in a similar manner (e.g., document scanners, digital cameras and so on). Conversely, all of the components shown in FIG. 8 need not be present to practice the present disclosure. The components can be interconnected in different ways from that shown. The operation of a computer such as that shown in FIG. 8 is readily known in the art and is not discussed in detail in this application. Code to implement the present disclosure can be stored in computer-readable storage media such as one or more of the memory 27, fixed storage 23, removable media 25, or on a remote storage location.

FIG. 9 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for the purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
receiving an API request comprising a description in an API language, the description comprising one or more HTTP protocols, methods, header policies, certificate data, origins, and routing rules;
configuring, by one or more asynchronous processes, a first content delivery network based on the description, wherein at least one of the one or more asynchronous processes interacts with at least one certificate service; and
configuring, by one or more additional asynchronous processes, a second content delivery network based on the description wherein the description is not changed based on configuration parameters of the second content delivery network, and wherein the configuration parameters of the second content delivery network are different from configuration parameters of the first content delivery network.

2. The computer-implemented method of claim 1, further comprising updating an append-only log of deployment requests with the description of the API request.

3. The computer-implemented method of claim 1, further comprising storing configuration patterns based on the description of the API request, and wherein at least one of the one or more asynchronous processes uses the configuration patterns when configurating the first content delivery network and at least one of the one or more additional asynchronous processes uses the configuration patterns when configurating the second content delivery network.

4. The computer-implemented method of claim 1, wherein configuring, by one or more asynchronous processes, a first content delivery network based on the description, wherein at least one of the one or more asynchronous processes interacts with at least one certificate service further comprises using by at least one of the one or more asynchronous processes a first driver to interact with the first content delivery network.

5. The computer-implemented method of claim 4, wherein configuring, by one or more additional asynchronous processes, a second content delivery network based on the description wherein the description is not changed based on configuration parameters of the second content delivery network, further comprises using by at least one of the one or more asynchronous processes a second driver to interact with the second content delivery network, wherein the first driver and second driver are separate drivers.

6. The computer-implemented method of claim 1, further comprising receiving a second API request comprising a second description in the API language, the second description comprising one or more HTTP protocols, methods, header policies, certificate data, origins, and routing rules; and
configuring, by one or more second additional asynchronous processes, the first content delivery network based on the second description, wherein at least one of the one or more second additional asynchronous processes interacts with at least one certificate service.

7. The computer-implemented method of claim 1, wherein configuring, by one or more asynchronous processes, a first content delivery network based on the description, wherein at least one of the one or more asynchronous processes interacts with at least one certificate service, further comprises:
performing, by at least one of the one more asynchronous processes, upsertion of certificates to the first content delivery network;
performing, by at least one of the one or more asynchronous processes, domain mapping on the first content delivery network.

8. A computer-implemented system comprising:
a storage; and
a processor that receives an API request comprising a description in an API language, the description comprising one or more HTTP protocols, methods, header policies, certificate data, origins, and routing rules;
configures, with one or more asynchronous processes, a first content delivery network based on the description, wherein at least one of the one or more asynchronous processes interacts with at least one certificate service; and
configures, with one or more additional asynchronous processes, a second content delivery network based on the description wherein the description is not changed based on configuration parameters of the second content delivery network, and wherein the configuration parameters of the second content delivery network are different from configuration parameters of the first content delivery network.

9. The computer-implemented system of claim 8, wherein the processor further updates an append-only log of deployment requests with the description of the API request.

10. The computer-implemented system of claim 8, wherein the processor further stores configuration patterns based on the description of the API request, and wherein at least one of the one or more asynchronous processes uses the configuration patterns when configurating the first content delivery network and at least one of the one or more additional asynchronous processes uses the configuration patterns when configurating the second content delivery network.

11. The computer-implemented system of claim 8, wherein the processor configures, with one or more asynchronous processes, a first content delivery network based on the description, wherein at least one of the one or more asynchronous processes interacts with at least one certificate service by further using with at least one of the one or more asynchronous processes a first driver to interact with the first content delivery network.

12. The computer-implemented system of claim 11, wherein the processor configures, with one or more additional asynchronous processes, a second content delivery network based on the description wherein the description is not changed based on configuration parameters of the second content delivery network, by further using with at least one of the one or more asynchronous processes a second driver to interact with the second content delivery network, wherein the first driver and second driver are separate drivers.

13. The computer-implemented system of claim 8, wherein the processor further receives a second API request comprising a second description in the API language, the second description comprising one or more HTTP protocols, methods, header policies, certificate data, origins, and routing rules, and
configures, with one or more second additional asynchronous processes, the first content delivery network based on the second description, wherein at least one of the one or more second additional asynchronous processes interacts with at least one certificate service.

14. The computer-implemented system of claim 8, wherein the processor configures, with one or more asynchronous processes, a first content delivery network based on the description, wherein at least one of the one or more asynchronous processes interacts with at least one certificate service, with performing, by at least one of the one more asynchronous processes, upsertion of certificates to the first content delivery network, and
performing, with at least one of the one or more asynchronous processes, domain mapping on the first content delivery network.

15. A system comprising: one or more computers and one or more non-transitory storage devices storing instructions, when executed which are operable by the one or more computers, to cause the one or more computers to perform operations comprising:
receiving an API request comprising a description in an API language, the description comprising one or more HTTP protocols, methods, header policies, certificate data, origins, and routing rules;
configuring, by one or more asynchronous processes, a first content delivery network based on the description, wherein at least one of the one or more asynchronous processes interacts with at least one certificate service; and
configuring, by one or more additional asynchronous processes, a second content delivery network based on the description wherein the description is not changed based on configuration parameters of the second content delivery network, and wherein the configuration parameters of the second content delivery network are different from configuration parameters of the first content delivery network.

16. The system of claim 15, wherein the instructions are operable, when executed by the one or more computers, to cause the one or more computers to perform operations further comprising updating an append-only log of deployment requests with the description of the API request.

17. The system of claim 15, instructions are operable, when executed by the one or more computers, to cause the one or more computers to perform operations further comprising storing configuration patterns based on the description of the API request, and wherein at least one of the one or more asynchronous processes uses the configuration patterns when configurating the first content delivery network and at least one of the one or more additional asynchronous processes uses the configuration patterns when configurating the second content delivery network.

18. The system of claim 15, wherein the instructions which are operable, when executed by the one or more computers, to cause the one or more computers to perform operations comprising configuring, by one or more asynchronous processes, a first content delivery network based on the description, wherein at least one of the one or more asynchronous processes interacts with at least one certificate service further cause the one or more computers to perform operations comprising using by at least one of the one or more asynchronous processes a first driver to interact with the first content delivery network.

19. The system of claim 18, wherein the instructions which are operable, when executed by the one or more computers, to cause the one or more computers to perform operations comprising configuring, by one or more additional asynchronous processes, a second content delivery network based on the description wherein the description is not changed based on configuration parameters of the second content delivery network, further cause the one or more computers to perform operations comprising using by at least one of the one or more asynchronous processes a second driver to interact with the second content delivery network, wherein the first driver and second driver are separate drivers.

20. The system of claim 15, wherein the instructions are operable, when executed by the one or more computers, to cause the one or more computers to perform operations further comprising receiving a second API request comprising a second description in the API language, the second description comprising one or more HTTP protocols, methods, header policies, certificate data, origins, and routing rules; and
configuring, by one or more second additional asynchronous processes, the first content delivery network based on the second description, wherein at least one of the one or more second additional asynchronous processes interacts with at least one certificate service.
